(19) United States
(12) Patent Application Publication
(10) Pub. No.: US 2004/0169344 A1
(43) Pub. Date: Sep. 2, 2004

(54) Mobile device

(76) Inventor: Hubert Seeberger, Ottobeuren (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/477,543

(22) PCT Filed: May 15, 2002
(86) PCT No.: PCT/EP02/05332

(30) Foreign Application Priority Data
May 15, 2001 (DE) 10123724.3

(51) Int. Cl. B62B 7/00

(52) U.S. Cl. 280/47.38

(57) ABSTRACT

According to the invention, the variability of a mobile device (1), comprising a support frame (10), at least one function unit (for example, 31) in modular form fixed thereto and at least one connecting means (100), may be increased, whereby the support frame (10) is embodied as a bar, the at least one module (20, 30, 40, 50, 200) in the form of a shell may be displaced above the support frame (10) along the longitudinal axis (L) thereof and comprises at least one function unit (for example, 31) and is fixed in an exchangeable manner by means of at least one connecting means (100),

The present invention relates to a mobile device being comprised of a support frame, of function units in modular form fixed thereto and of connecting means.

In the field of mobile devices for children, many different types are known e.g., tricycles, chain-driven small vehicles having the shape of a car or what are termed “soapbox cars”. A great number of devices are further known by means of which parents may push or pull their children, such as tricycles the pedal mechanism of which may be disabled by the parents who may then push the child sitting on the tricycle by means of a push rod that may be mounted thereon. Another form of pulled mobile device to be mentioned is the bike trailer. These trailers are configured in such a manner that they can be attached to a bicycle and that the children can be seated in said trailer. However, all of these mobile devices suffer from the disadvantage that they are not sufficiently variable. Although the existing available tricycles may be pushed by the parents, this variability is, generally speaking, very restricted.

Another disadvantage is that most of these mobile devices are only right for a certain age group and that, after a few years, the parents have to buy new vehicles for their children. At age three, children drive a small plastic car, later, they want a tricycle before they prefer e.g., a “soapbox”. Moreover, most children have several mobile devices that require large storage area. The mobile devices required in early childhood are often relegated to some storage room where they are left unused. This more specifically also applies to coasters, trailers or strollers the functionality of which depends on the age of the child.

one approach to overcoming this problem is described in DE-A-42 18 187. This document describes a base frame of an all-round bike trailer. Said base frame consists of hollow profiles connecting two confronting axle journals. As a result, the frame concurrently forms the axle of the wheels. Said axle frame is adapted to receive commercially available bucket seats for bicycles or boxes for transporting baggage that are attached thereon. It further provides the possibility to mount a roll bar and a draw bar thereon. This provides for a certain variability since two child seats may for example be mounted thereon. The major disadvantage of this base frame however is that, although it may be modified to some extent, it only permits to have one bicycle trailer that cannot be converted from a child bicycle trailer into a coaster or a soapbox.

It is therefore the object of the present invention to provide a mobile device that avoids the disadvantages described herein above. The invention more specifically aims at providing a mobile device that is extremely variable and occupies little space while enabling its use in a great diversity of applications, and that more specifically may be used as a pulled, pushed and automobile device which can be disassembled and compactly stored.

The solution to this object is accomplished by a mobile device according to claim 1. Advantageous implementations are recited In the dependent claims.

The mobile device in accordance with the invention consists of a support frame, of at least one function unit in modular form fixable thereto and of at least one connecting means, the support frame taking on the shape of a longitudinal bar or of a rod and being preferably configured to be a hollow aluminum extrusion profile. The support frame further preferably comprises a plurality of holes that extend through the support frame in a direction transverse to the longitudinal axis. The at least one module is thereby shaped like a clamp or a shell and is slidable over the support frame along the longitudinal axis thereof. Further, the module preferably also comprises holes that may be brought to mate with the holes of the support frame, at least one function unit being fixed to the module.

Through the holes, the support frame and the exchangeable modules are connectable by means of a connecting means, more specifically by means of a respective socket pin. The term function unit as used herein includes all elements that are suited to operate a mobile device. We will mention here, by way of example; seat buckets, bike seats, wheels, bearing devices, pulling and pushing devices, sails, paddle wheels, runners or like elements. These modules are easy to mount and dismount at will, the disassembled frame and modules occupying little space so that the parents may carry these in a rucksack or a bag, more specifically when they go for a walk. When the need arises, the child, which is no longer willing to walk for example, can be seated into the swiftly assembled trailer and be pulled.

The major advantage of the present mobile device is that it is almost infinitely variable. The modules may be combined with any of the function units and may be mounted at will onto the support frame. For example, a stroller seat may first be mounted to the support frame which may then, in later years, be replaced by a seat bucket. Furthermore, assembled in this way, a stroller can be both pushed and used for example as a bike trailer. For this purpose, the module with the pushing device needs merely be replaced by a module provided with the pulling device and the stroller seat be displaced at need along the support frame to optimize the center of gravity. Later, pedal bearings may be attached thereon for the child to be capable of driving the mobile device by itself. Another advantage is that baggage carriers may also be temporarily attached thereon in a simple manner, which is particularly advantageous when the parents take the child for shopping.

Yet another advantage is that the center of gravity of the mobile device may be chosen and changed at will. For example, a center of gravity located in proximity to the fulcrum is advantageous when the mobile device is to be pulled for this ensures good cornering stability. On the other hand, when used as a pushed vehicle, it is advantageous to move the center of gravity away from the pushing device for this enhances the mobility of the mobile device. Configuring the mobile device to be a support frame with slidable modules mounted thereon ensures both great stability and great functionality. Another advantage is that the mobile device can “grow” together with the child and that for example the distance between a mounted seat: and a pedal bearing or a steering wheel may be adjusted to the child's body size.

There is preferably provided that the mobile device comprise a plurality of modules. Said modules may be combined and arranged at will. Possible function units are, by way of example: casters, wheels, runners, seat, baby basket, baggage box, footrests, push rod, draw bar, stand, chain drive, roll bar, sunshade, sail or brakes.

The invention will be described and explained in closer detail herein after with reference to the drawings in which

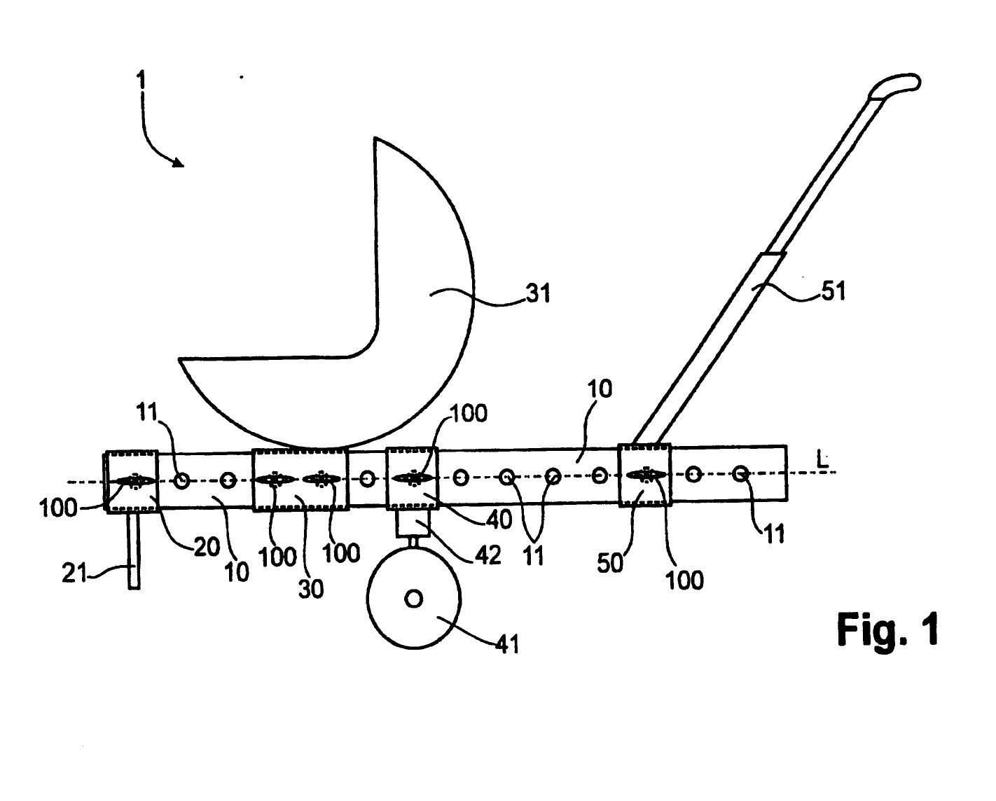

FIG. 1 is a side view of a mobile device in accordance with the invention;

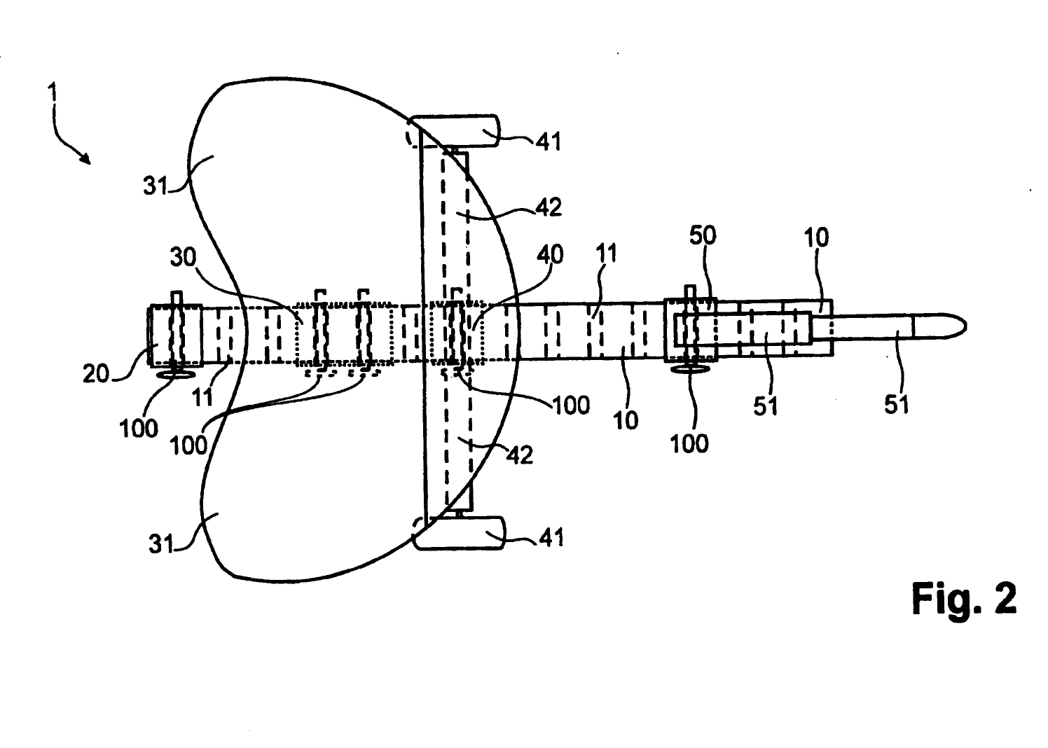

FIG. 2 is a top view of the mobile device of FIG. 1;

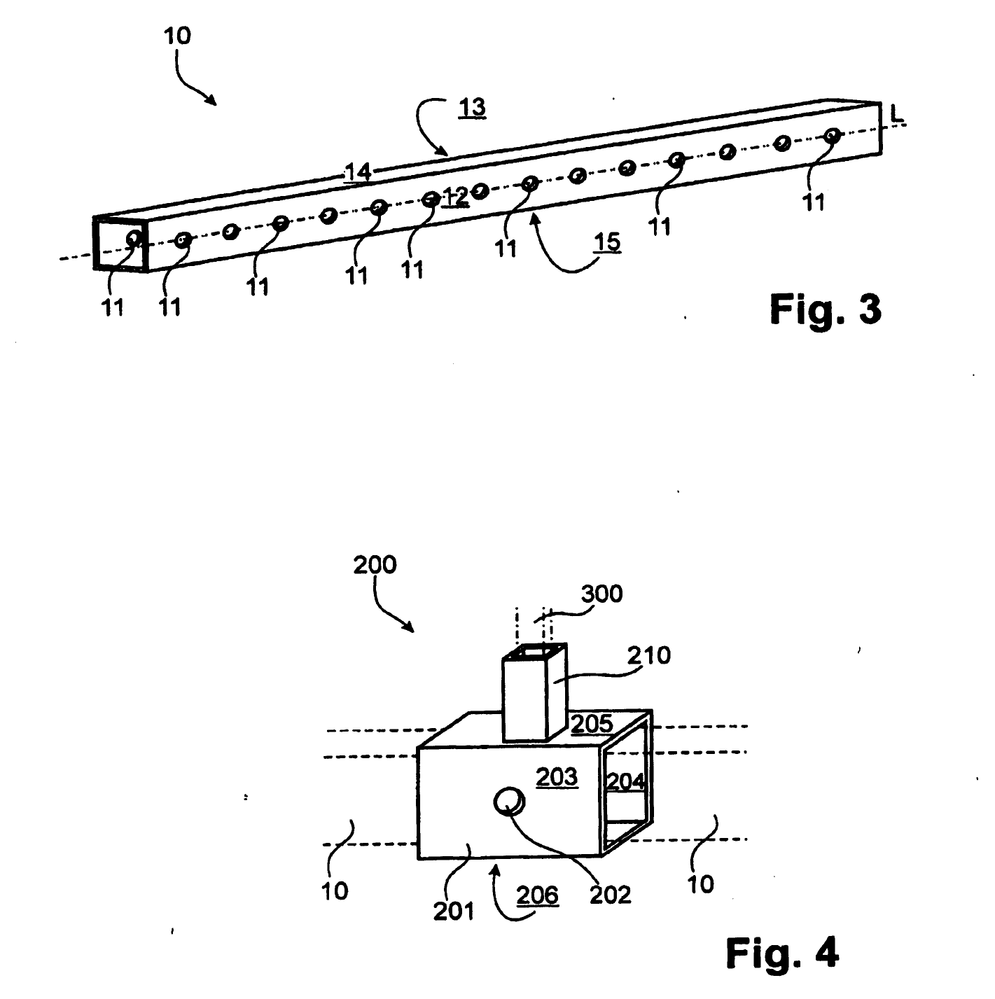

FIG. 3 is a perspective view of an exemplary embodiment of a support frame in accordance with the invention; and

FIG. 4 is a perspective view of a module.

With reference to FIGS. 1 and 2, a mobile device 1 comprises a support frame 10 formed in a bar- or rod-shaped configuration with holes 11 being provided along the longitudinal axis L thereof in a preferably uniformly spaced-apart relationship. The holes 11 extend through the support frame 10 so that socket pins may interlockingly engage therein. Spring-loaded stop bolts or quick acting closures may be provided in the same way to provide a form-positive or self-adhering connection. Further, a number of modules fixed to the support frame 10 are provided for the mobile device 1. The common feature of all of the modules is that they have a shell and are slidable along the longitudinal axis L of the support frame 10. Further, the modules are each comprised of a function unit that is fixed to the module. The general shape of a module will be explained in closer detail with reference to FIG. 4.

In the exemplary embodiment of FIG. 1, the module 20 used has a stand 21. Another module, which carries a seat 31 that may possibly be folded, is also utilized. The mobile device 1 moreover comprises a module 40 that is equipped with a function unit consisting of two casters 41 carried by an axis 42. Yet another module is provided which is module 50 that is comprised of a push-rod 51. In the exemplary embodiment of FIG. 1, the push rod 51 is configured to be a telescopic rod for compact stowage. From FIG. 1 it can also be seen that the mobile device 1 comprises connecting means 100 for connecting the support frame 10 and the modules 20, 30, 40, 50, etc. and for fixing their position. The connecting means 100 utilized are for example socket pins or spring-loaded stop bolts. Screws with nuts that lockingly engage into a longitudinal groove on the bar-shaped support frame 10, or clamps or hinged closures may also be used. The module shown in FIG. 4 may for example comprise a clamp that may be hinged open. From FIG. 1 it can further be seen that the modules 20, 30, 40 and 50 may cover, and use for fixation, only one hole 11 each (modules 20, 40, 50) but that, for a particularly stable connection, they may also cover a plurality of holes 1 (module 30).

From the top view of FIG. 2, the arrangement and slidability of the modules is even more obvious. A number of holes 11, shown in dashed line, are provided along the length of the support frame 10. The modules 20, 30, 40 and 50 are mounted to said support frame together with their corresponding function units, by pulling them over it. As a result, they may be replaced and displaced relative to one another at will. If a clamp is. used that may be hinged open, individual modules may be added or removed without having to displace the other modules.

A support frame 10 is illustrated separately in FIG. 3. The support frame 10 has a longitudinal axis L and is basically shaped like a bar or a rod. The support frame 10 is preferably configured to be hollow in the fashion of a rectangular tube. It may also be a stable wooden bar, though. Like in the exemplary embodiment of FIG. 3, the cross-section of the support frame 10 may be angular, more specifically rectangular or squarer it may also be oval though. A support frame 10 with a rectangular cross-section is preferred in order to provide a good bearing area for the modules. Preferably along its entire longitudinal axis L, the support frame 10 is comprised of a plurality of holes 11. There is preferably provided that the holes 11 extend horizontally through the support frame 10, meaning that they are arranged in the side faces 12 and 13, although it is also possible to have them extend vertically through the upper and lower faces 14 and 15, This facilitates mounting on the one hand and increases the stability of the fixation as well. For assembling the mobile device, the corresponding modules are pulled onto the support frame 10 and displaced along the longitudinal axis L thereof. The. holes 11 of the support frame 10 are brought to mate with the holes of the respective one of the modules. Then, the respective one of the modules is fixed to the support frame 10 by means of a bolt-shaped connecting means 100.

FIG. 4 shows a basic structure of a module 200. Module 200 consists of a shell-shaped base member 201. Said base member may be pulled over the support frame 10 and is slidable thereon (outlined in dashed line). Accordingly, the base member 201 has a shape that is adjusted (with little clearance) to the basic shape of the support frame 10. If the support frame 10 used is for example rectangular, the shape of the base member 201 must be rectangular as well. Further, the base member 201 preferably has at least one hole 202. If the base member 201 is longer so that it covers a plurality of holes 11 in the support frame 10, a plurality of holes 202 with the same modular dimensions are preferably provided, more specifically in order to ensure a particularly stable hold of the module on the support frame 10. The holes of module 200 are provided on the side faces 203 and 204 in a manner analogous to that of the holes of the support frame 10. If the holes 11 of the support frame 10 are provided on the upper face 13 or on the lower face 14 thereof, the holes of module 200 are of course accordingly provided on the upper face 205 or on the lower face 206 thereof.

Further, each module 20, 30, 40, 50 and so on is comprised of a function unit. Like in the exemplary embodiment shown in the FIGS. 1 and 2, this function unit may be firmly attached to the corresponding module 20, 30, 40 and 50. Module 200 of FIG. 4 however is provided with a replaceable function unit. For this purpose, the module 200 is provided with a plug and socket device 210. A function unit may be attached to said plug and socket device 210 by means of a corresponding mating part (outlined in dash-dot line 300). According to need, the function unit may also be fixed, for example through plugs, split pins, screws or other securing means. For technical manufacturing reasons, such a universal module 200 is advantageous for one or two basic module shapes only have to be provided and the function units can be manufactured as corresponding individual parts. This also provides the user with a variety of advantages since he only needs for example to have a certain number of clamp- or shell-shaped modules 200 on hand while still having, thanks to the many function units, almost unrestricted combination possibilities for assembling an individual child vehicle.

1. A mobile device having a support frame, at least one function unit in modular form that is fixable thereto and at least one connecting means,
characterized in that
the support frame (10) is configured to be shaped like a bar or a rod, with the at least one module (20, 30, 40, 50, 200), which is shaped like a shell, being slidable on the support frame (10) along the longitudinal axis (L) thereof, comprising at least one function unit (21, 31, 41, 51) and being replaceably secured to the support frame (10) by means of at least one connecting means (100).

2. The mobile device in accordance with claim 1,
characterized in that
the mobile device (1) comprises a plurality of modules (20, 30, 40, 50, 200) with the respective one of the function units (21, 31, 41, 51) being selectable from the group comprising casters wheels, runners, seats, boxes, footrests, push rods, draw bars, stands, chain drives, roll bars, sunshades or brakes.

3. The mobile device in accordance with claim 1 or 2,
characterized in that
the mobile device (1) comprises a module (200) the function unit (21, 31, 41, 51) of which is replaceable and is more specifically configured like a plug-type connection (210/300).

4. The mobile device in accordance with any of the claims 1 through 3,
characterized in that
the support frame (10) is configured to be hollow.

5. The mobile device in accordance with any of the claims 1 through 4,
characterized in that
the support frame (10) has a rectangular or oval cross-section and more specifically consists of a hollow aluminum extrusion profile.

6. The mobile device in accordance with any of the claims 1 through 5,
characterized in that
a number of holes (11) are disposed in the support frame (10) and that at least one hole (202) is disposed in the base member (201) of the module (200).

7. The mobile device in accordance with claim 6,
characterized in that
the holes (11; 202) are disposed in confronting side faces (12, 13, 203, 204) of the support frame (10) or of the base member (201).

8. The mobile device in accordance with claim 6 or 7,
characterized in that
the holes (11) are uniformly spaced along the support frame (10).
